(19) United States
(12) Patent Application Publication
(10) Pub. No.: US 2012/0320092 A1
(43) Pub. Date: Dec. 20, 2012

(54) METHOD AND APPARATUS FOR EXHIBITING MIXED REALITY BASED ON PRINT MEDIUM

(75) Inventors: Hee Sook Shin, Daejeon (KR); Hyun Tae Jeong, Daejeon (KR); Dong Woo Lee, Daejeon (KR); Sungyong Shin, Daejeon (KR); Jeong Mook Lim, Daejeon (KR)

(73) Assignee: ELECTRONICS AND TELECOMMUNICATIONS RESEARCH INSTITUTE, Daejeon (KR)

(21) Appl. No.: 13/495,560

(22) Filed: Jun. 13, 2012

(30) Foreign Application Priority Data
Jun. 14, 2011 (KR) 10-2011-0057559

(51) Int. Cl. G09G 5/00

(52) U.S. Cl. 345/633

(57) ABSTRACT

An apparatus for exhibiting mixed reality based on a print medium includes a command identification module and a content reproduction module. The command identification module identifies a hand gesture of a user performed on a printer matter in the print medium to recognize a user input command corresponding to the hand gesture. The content reproduction module provides a digital content corresponding to the printed matter onto a display area on the print medium.

### RELATED APPLICATION(S)

This application claims the benefit of Korean Patent Application No. 10-2011-0057559, filed on Jun. 14, 2011, which is hereby incorporated by references as if fully set forth herein.

### FIELD OF THE INVENTION

The present invention relates to a technology of exhibiting mixed reality, and more particularly, an apparatus and method for exhibiting mixed reality based on a print medium, which provides the integration of virtual digital contents and the print medium in reality.

### BACKGROUND OF THE INVENTION

As well-known in the art, many researches are ongoing on a technology for augmenting information in the real world by adding virtual contents to an object in the real world. Technical development has been achieved by various approaches, starting from a virtual reality technology of mainly representing virtual reality to an augmented reality technology of adding virtual information based on the real world and a mixed reality technology of attempting to appropriately mix reality with virtual reality.

Especially, as terminals, such as smart phones, having an improved computing capability and a camera function, are widely used, a mobile augmented reality (AR) technology has been on the rise. The mobile AR technology is providing various services, such as adding virtual information required by a user to an ambient environment during movement. However, most of mobile AR technologies merely provide both an actual image and virtual information through a display device mounted in a terminal. Thus, the user still feels imaginarily the virtual information existing within the terminal, and an input method for providing the virtual information is still performed through the general operation in the terminal.

In addition, with the introduction of user equipment, such as a mobile phone having a small projector attached thereto, an attempt to use the projector as a new display device is being made. This is also utilized as a service to provide a large screen, without limit to a small display screen, for allowing many persons to watch a movie and share information, and the like.

A new service concept using the output function of the projector and the input function of the camera has been introduced, as Sixth Sense, by Massachusetts Institute of Technology (MIT). According to this concept, user's hand gestures are input as camera images for use and information as a new display or a part of an actual object is added to an image projected through the projector, such that digital information that is integrated with information about the actual object can be provided to the user as if they are originally one information. For example, when a user views a paper with a picture printed thereon, the user can view not only the printed picture of the paper but also a video of the picture through an image being projected in real time. In addition, changed flight information is additionally exhibited on printed flight information within the ticket, thereby expressing virtuality of the digital information to be more realistic.

Due to recent development of technologies, a projector and a camera which are reduced in size are mounted in a mobile device. Thus, a system for providing various services by fabricating the small projector and camera in a wearable form is being introduced, and also a system for allowing the small projector and camera to be usable during movement by fabricating them in a portable form is being developed. The use of those systems enables digital information to be exhibited or displayed on a real-world object other than a screen of a digital terminal, and also allows for creation of new services. However, the portable type system as introduced above has a limitation of concentrating on exhibiting digital information and direct user interactions by using a projected region itself as a new display area, rather than creation of new contents through integration between information provided by an actual object and virtual information.

Further, the wearable type system such as the Sixth Sense is employing a method of attaching markers with specific colors onto user's fingers and attaching a separate sensor onto an actual object, which may lower practical utilization.

### SUMMARY OF THE INVENTION

In view of the above, the present invention provides an apparatus and method for exhibiting mixed reality based on a print medium, which provides the integration of virtual digital contents and the print medium in reality.

Further, the present invention provides an apparatus and method for exhibiting mixed reality based on a print medium, which provides a space for digital contents exhibition and a space for a user's input command within an actual reality space to allow an intuitive user input command.

Further, the present invention also provides an apparatus and method for exhibiting mixed reality based on a print medium, which are capable of allowing recognition of a user's input command and an output of digital contents without a separate marker.

In accordance with an aspect of the present invention, there is provided an apparatus for exhibiting mixed reality based on a print medium, which includes: a command identification module configured to identify a hand gesture of a user performed on a printer matter in the print medium to recognize a user input command corresponding to the hand gesture; and a content reproduction module configured to provide a digital content corresponding to the printed matter onto a display area on the print medium.

Preferably, the command identification module includes: a pattern image output unit configured to generate a pattern image on the printed medium, the hand gesture causes a change in the pattern image; an image acquiring unit configured to capture an image of the surface of the printed medium, wherein the captured image has the pattern image included therein, and wherein the hand gesture causes the change in the pattern image; and a command recognizing unit configured to detect the pattern image caused by the hand gesture to recognize the user input command corresponding to the hand gesture.

Preferably, the pattern image includes an image in a grid form projected onto the print medium at a preset period.

Preferably, the pattern image includes an infrared image invisible to the user.

Preferably, the command identification module further includes a command model database that stores a plurality of command models corresponding to hand gestures representative of user input commands; and wherein the command recognition unit is configured to match the hand gesture with the command models to find out a command model corresponding to the hand gesture.

Preferably, the command identification module further comprises an environment recognizing unit that is configured to analyze the captured image of the print medium to find the display area appropriate for presenting the digital content.

Preferably, the environment recognizing unit is further configured to collect display environment information from the captured image of the print medium, the display environment information including at least one of information related to size, brightness, flat state or distorted state of the display area.

Preferably, the apparatus further includes a content management module that is configured to format the digital content based on the display environment information of the display area and provide the digital content to the content reproduction module.

Preferably, the content reproduction module includes an image correction unit that is configured to correct the image of the digital content based on the display environment information.

In accordance with another aspect of the present invention, there is provided a method for exhibiting mixed reality based on a print medium, which includes: generating a pattern image onto the print medium, wherein a hand gesture of a user is interacted with a printed matter in the printed medium to produce a user input command; identifying the hand gesture causing a change in the pattern image to recognize the user input command; and projecting digital content corresponding to the printed matter onto a display area of the print medium depending on the user input command.

Preferably, the generating a pattern image onto the print medium includes projecting an image in a grid form onto the print medium at a preset period.

Preferably, the identifying the hand gesture includes: capturing an image of the print medium, the captured image including the pattern image; detecting the change in the pattern image caused by the hand gesture; and

matching the hand gesture with a plurality of command models to find out a command model corresponding to the user input command.

Preferably, the pattern image includes an infrared image invisible to the user.

Preferably, the method further includes: analyzing the captured image to find a display area appropriate for reproducing the digital contents on the print medium.

Preferably, the method further includes: collecting display environment information including at least one of information related to size, brightness, flat state and distorted state of the display area.

Preferably, the method further includes: formatting the digital content based on the collected display environment information.

Preferably, the method further includes: correcting an image of the digital content reproduced on the display area based on the collected display environment information.

### BRIEF DESCRIPTION OF THE DRAWINGS

The above and other objects and features of the present invention will become apparent from the following description of embodiments, given in conjunction with the accompanying drawings, in which:

FIG. 1 is a block diagram of an apparatus for exhibiting mixed reality based on a print medium in accordance with an embodiment of the present invention;

FIGS. 2A and 2B are exemplary views showing a sequence of image frames captured from the surface of the printed medium and pattern image frames separated from the sequence of image frames, respectively;

FIG. 3 is an exemplary apparatus for exhibiting mixed reality based on a print medium in accordance with an embodiment of the present invention;

FIGS. 4A and 4B illustrate changes in pattern images projected on the print medium shown in FIG. 3, by means of user's hand gestures;

FIG. 5 is a flowchart illustrating a method for exhibiting mixed reality based on a print medium in accordance with an embodiment of the present invention;

FIGS. 6A to 6J illustrate various examples of the hand gesture models; and

FIG. 7 is an exemplary view showing a print medium having digital content projected thereon in accordance with an embodiment of the present invention.

### DETAILED DESCRIPTION OF THE EMBODIMENT

Hereinafter, embodiments of the present invention will be described in detail with the accompanying drawings.

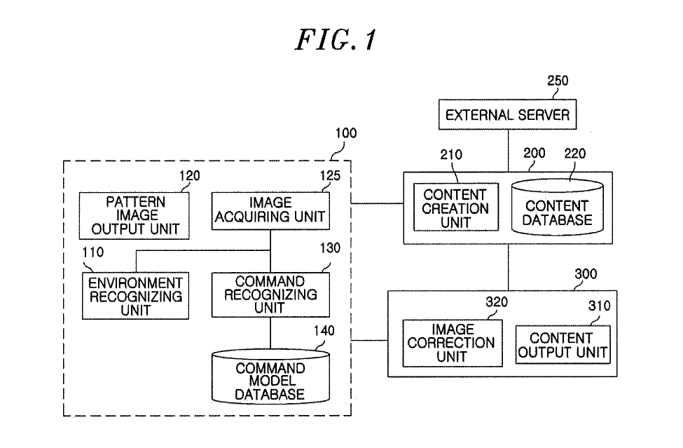

FIG. 1 is a block diagram of an apparatus for exhibiting mixed reality based on a print medium in accordance with an embodiment of the present invention.

As shown in FIG. 1, an apparatus for exhibiting mixed reality based on a print medium includes a command identification module 100, a content creation module 200, and a content reproduction module 300. The command identification module 100 identifies interaction of a user performed using his/her fingers on a print medium, for example, hand gestures, to recognize user's input commands corresponding to the hand gestures. The hand gestures may be used to issue user's input commands like a mouse movement event or a mouse click event.

In the embodiment, the print medium may includes such as a story book, an illustrated book, a magazine, an English language teaching material, an encyclopedia, a paper or the like. The printed medium has printed matters thereon such as printed words, printed pictures or images, or the like. When a user interacts with a printed matter on the printed medium or an image projected onto the printed medium using the hand gesture, virtual digital content corresponding to the printed matter may be reproduced or represented onto a certain area on the printed medium in real world. The command identification module 100 includes an environment recognizing unit 110, a pattern image output unit 120, an image acquiring unit 125, a command recognizing unit 130, and a command model database 140.

The pattern image output unit 120 projects a pattern image on the surface of the print medium at a preset period or in a consecutive manner. The pattern image projected onto the surface of the print medium has the form of stripe patterns or the form of a grid pattern as shown in FIG. 3.

It is preferable that the pattern images are invisible to a user not to interfere with the visibility of the printed matters in the printed medium for which the projected pattern will be confusing. Hence, there may be a limitation on the number of pattern images capable of being projected onto the printed medium per unit time.

Therefore, the pattern image output unit 320 may be implemented with a structured-light 3D scanner which projects a specific pattern of infrared light onto the surface of the print medium or a diffraction grating which forms specific patterns of infrared light by means of diffraction of laser beams. The infrared pattern image is invisible to a user, and therefore the number of pattern images capable of being inserted per time may rarely be limited. Further, if it is necessary to project many pattern images in order to increase a performance of identifying the respective hand gestures, the use of an extremely high frame rate pattern image may satisfy the need.

The image acquiring unit 125 captures an image of the surface of the print medium depending on a preset period at which the pattern image output unit 120 projects the pattern image. The captured image includes the pattern image on which a hand gesture of a user is performed on the printed matter in the print medium. For an infrared pattern image, the image acquiring unit 125 may be implemented as an infrared camera for capturing an infrared pattern image projected onto the print medium. The captured image is then provided to the environment recognizing unit 110 and the command recognizing unit 130.

The environment recognizing unit 130 analyzes the captured image of the print medium to find a display area for presenting digital content corresponding to the printed matter exerted by the hand gesture on the print medium. The environment recognizing unit 130 also collects display environment information including at least one or all of information relating to size, brightness, a flat state or a distorted state related to the display area. That is, the environment recognizing unit 110 collects in advance required display environment-related information, such as whether or not the display area is flat or whether or not the display area is distorted, for presenting digital content in reality through a projection.

The command model database 140 stores a plurality of command models corresponding to the hand gestures representative of the user's input commands.

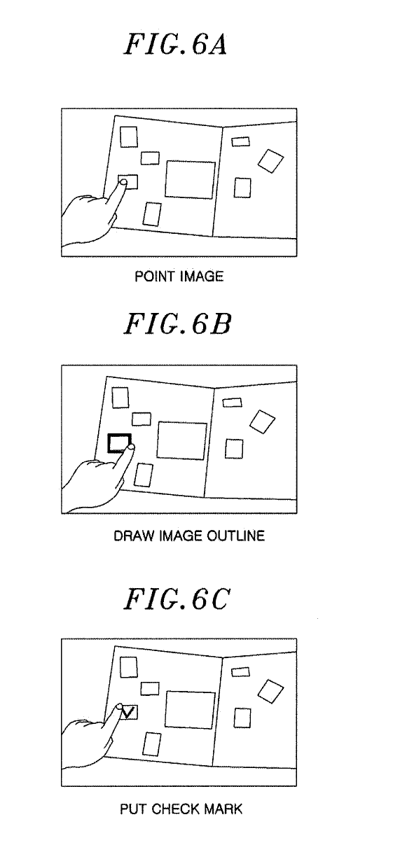

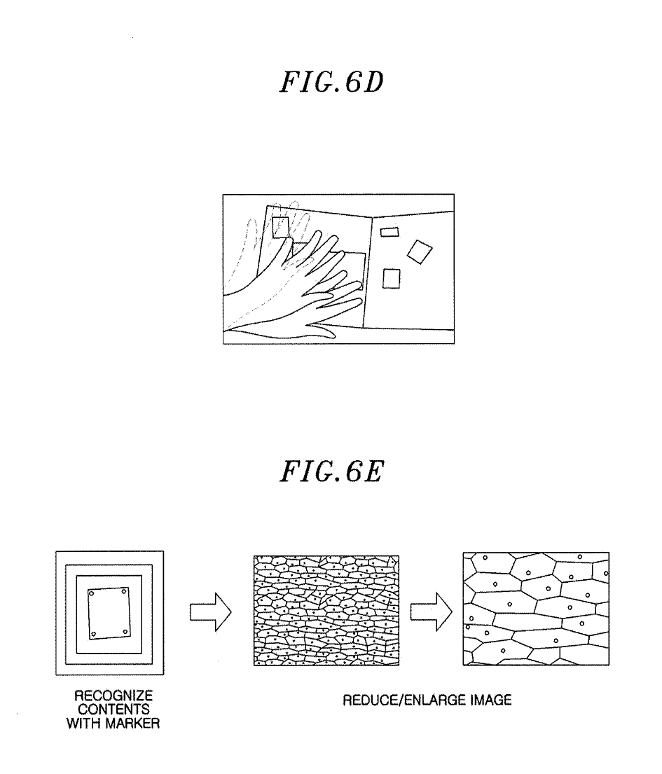

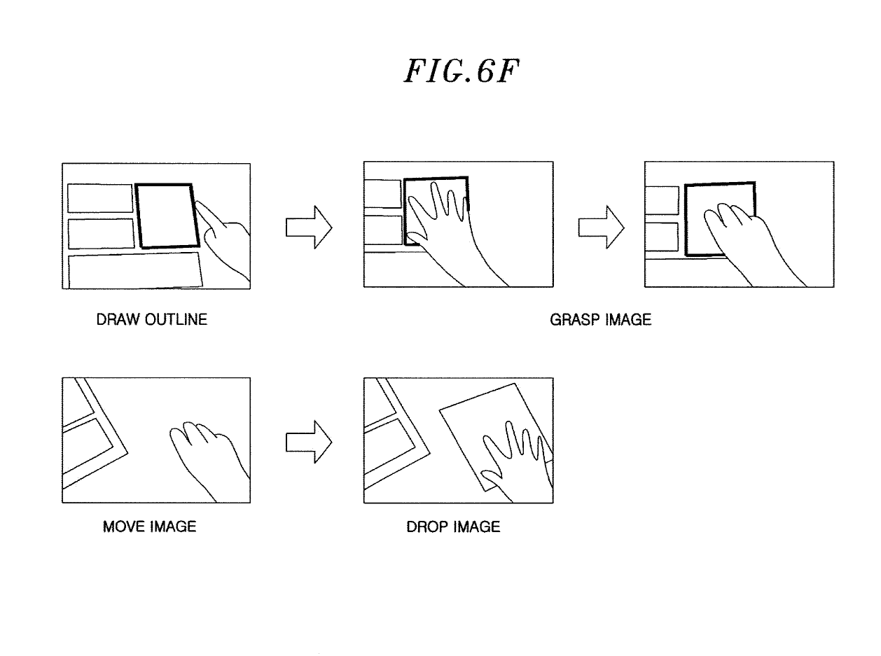

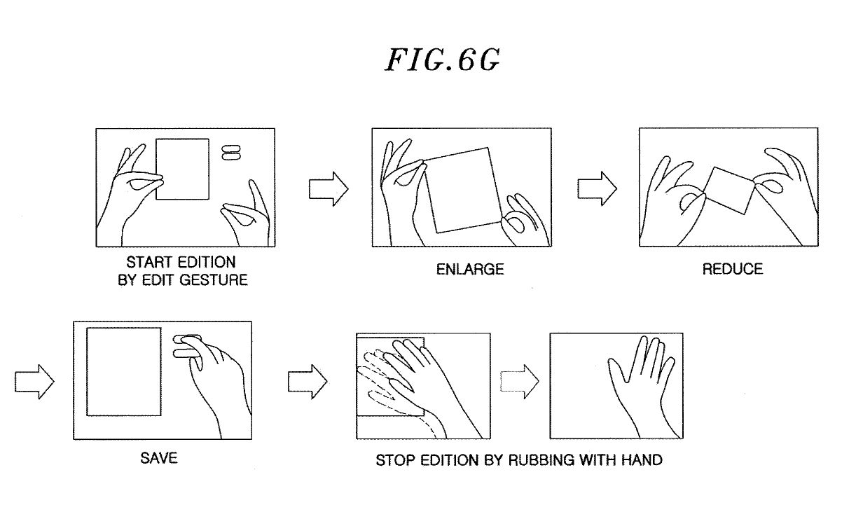

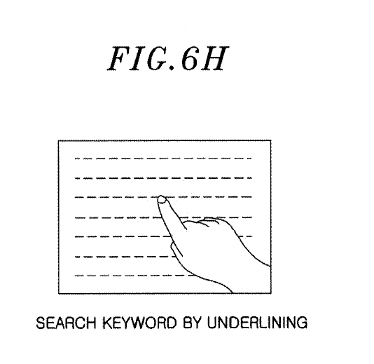

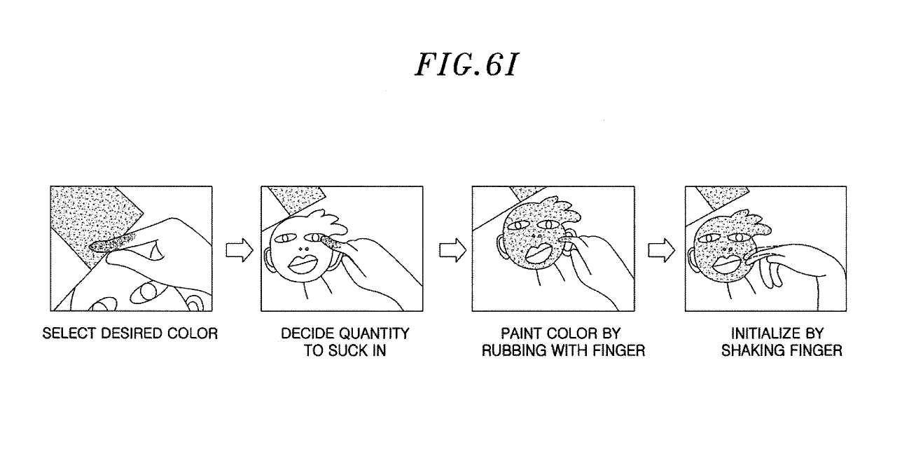

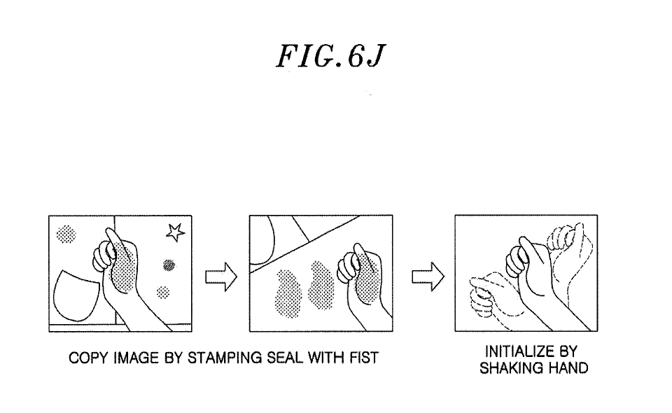

When the print matter in the print medium, onto which the pattern image is projected, is touched by the hand gesture, it may cause a change in the pattern image. The command recognizing unit 130 detects the change in the pattern image by the hand gesture to recognize the input of a user's command corresponding to the hand gesture. More specifically, when the command recognizing unit 130 detects the change in the pattern image, it matches the hand gesture with the command models to find out a command model corresponding to the hand gesture, which becomes the user's input command. The hand gesture may include, for example, underlining on a word included in the print medium on which the pattern image has been projected or pointing vertexes of a picture included in the print medium with a finger, which will be discussed with reference FIG. 6A to 6J.

FIGS. 6A to 6J illustrate various examples of the hand gesture models stored in the command model database 140. FIGS. 6A, 6B and 6C illustrate hand gestures for pointing at a printed matter in the print medium, drawing an outline of a printed matter in the print medium, and putting a check mark onto a printed matter in the print medium in order to issue an user input command for reproducing the digital content corresponding to the printed matter in the display area on the print medium.

FIG. 6D shows a hand gesture rubbing the printed matter in the print medium in order to issue a user input command for pausing the reproduction of a digital content corresponding to the printed matter.

FIG. 6E illustrates a hand gesture for an enlargement or reduction command of a digital content, e.g., a picture, reproduced in the display area in the print medium. As shown in FIG. 6E, a marker 600 is used to recognize the selection of the digital content. Thereafter, touching the digital content more than once may induce to enlarge or reduce the recognized digital content. Here, a magnification of enlargement or reduction may depend on the number of touching.

FIG. 6F illustrates hand gestures corresponding to a copy command of a printed matter, e.g., a printed image, in the print medium. As shown in FIG. 6F, an outline is drawn on the printed image in the print medium desired to be copied, and the copied image is projected onto the back of a hand through a gesture of grasping the image. The projected image is then moved to a desired area and then copied on the desired area through a gesture of dropping the projected image onto the desired area.

FIG. 6G illustrates hand gestures for an edit command for a printed matter, e.g., a printed image, in the printed medium. As shown in FIG. 6G, an edit command begins with a hand gesture to stretch or shrink the printed image with two hands in a diagonal direction, thereby reducing and/or enlarging the printed image. Upon edition of the printed image, a store button or a cancel button may also be projected next to the printed image, and an edited printed image may be stored or the edition may be canceled through a gesture of touching the store or cancel button. Further, In addition, a gesture of rubbing the edited printed image with hand may stop the edition on the edited printed image.

FIG. 6H illustrates a hand gesture for keyword search. As shown in FIG. 6H, a printed word in the printed medium desired to be searched may be underlined to execute search for the printed word. For example, the result of the search may be viewed near the printed word while highlighting the printed word.

FIGS. 6I and 6J illustrate hand gestures for application of music/art education.

As shown in FIG. 6I, a finger may be used as a spuit. For example, a desired color is pointed with an index finger to select the desired color, a hand gesture of sucking up the color is taken using a thumb finger to extract the color by a desired quantity to suck in, and a hand gesture of painting is taken at a desired area with the extracted color. Further, the painting operation may be initialized by shaking finger.

As shown in FIG. 6J, a hand gesture to repetitively hit a printed image in the printed medium desired to be copied with a fist as if the user stamps a seal, thus to copy the printed image. The copying is repetitively performed by taking the same gesture on desired places depending on the same manner like stamping a seal. The copying operation may be initialized by a gesture of shaking a hand.

The content management module 200 controls selection, creation, modification and the like of the digital content corresponding to the printed matter in the print medium depending on the user input command recognized by the command identification module 100. The content creation module 200 includes a content creation unit 210 and a content database 220.

The content creation unit 210 reconstructs the digital content corresponding to the printed matter based on the display environment information collected by the command identification module 100. The digital content to be displayed on the display area in the print medium may fetched from the local content database 220 or provided from an external server 250 via a network. The digital content provided from the local content database 220 or the external server 250 may have a structure which is improper to the display environment. In this case, the content creation unit 210 may modify, format or reconstruct the digital content to be compatible with the display environment, such as the size of the display area or the like.

The content database 220 stores user interfaces that frequently used by the user and digital content to be displayed on the display area in the print medium.

The content reproduction module 300 projects the digital content onto the display area in the print medium. The content reproduction module 300 includes a content output unit 310 and an image correction unit 320. The content output unit 310 projects the digital content provided by the content management module 200 onto the display area of the print medium. For example, the content output unit 310 is implemented as a projector, which projects digital content onto the display area in the print medium in reality to reproduce the images of the digital content. In addition, the content output unit 310 may adjust a focus of the projector, a projection direction of the projector and the like to avoid a visibility-related problem when projecting the digital content onto the display area. The image correction unit 320 corrects the images of the digital content projected by the content output unit 310 based on the display environment information. Color and brightness of the image of the digital content may be changed depending on the display environment information. The image correction unit 320 corrects the image of the digital content to be actually displayed in advance because exhibition of the color or brightness of the image of the digital content may actually change depending on features of the display area of the print medium. Further, when the display area on which the image of the digital content is projected is not flat, distortion in the image of the digital content may be caused. Hence, the image correction unit 320 corrects the image of the digital content to be projected in advance by performing geometric correction of the image.

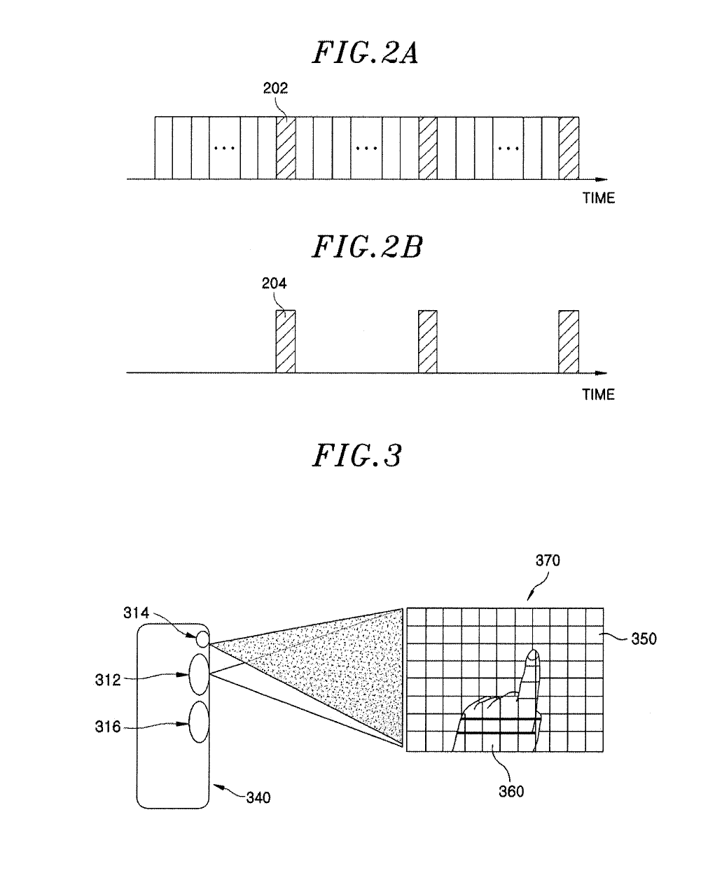

FIGS. 2A and 2B are exemplary views showing a sequence of image frames of the surface of the printed medium with pattern image frames and pattern image frames, respectively.

As shown in FIG. 2A, the sequence of image frames includes the pattern image frames 202 that are inserted at a preset period, e.g., a preset frame period. FIG. 2B illustrates pattern images 204 separated from the sequence of image frames at the preset frame period. FIG. 3 is an exemplary apparatus for exhibiting mixed reality based on a print medium in accordance with an embodiment of the present invention. In FIG. 3, the apparatus is illustrated to include a scanner 314 and a camera 316 respectively corresponding to the pattern output unit 120 and the image acquiring unit 125 shown in FIG. 1, and another projector 312 corresponding to the content output unit 310 shown in FIG. 1. The scanner 314, the camera 316 and the projector 312 are all incorporated in a single housing 340.

Optionally, the apparatus may be configured such that the projector 312 inserts or overlaps a pattern image directly into or with an image of the digital content projected by the projector 312. In this case, the scanner 314 may be omitted from the apparatus for exhibiting mixed reality based on a print medium of the embodiment of the present invention.

On the right part in FIG. 3, a pattern image 350 projected onto the print medium has a grid pattern, wherein a reference numeral 370 denotes a portion of the print medium. When a user touches a printed matter in the print medium 380 with a finger 360 onto which the grid pattern 350 is projected, the hand gesture may cause a change in the pattern image.

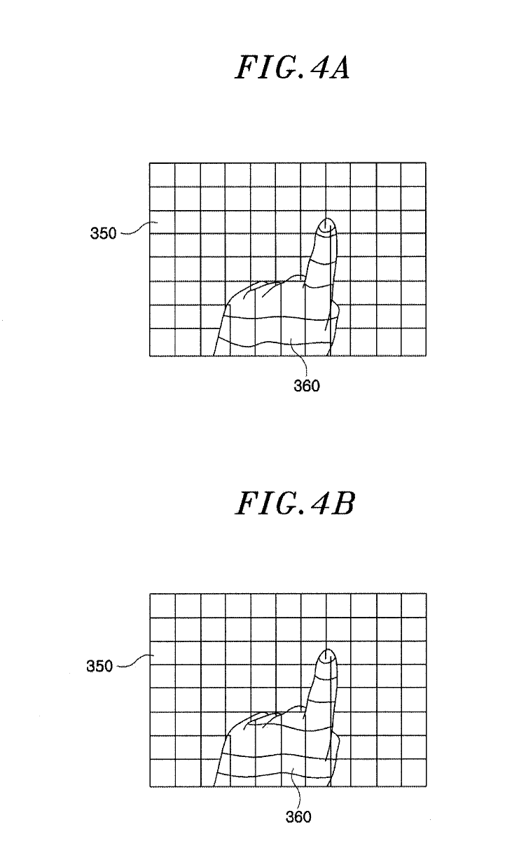

FIGS. 4A and 4B show changes in the pattern image, projected on the print medium shown in FIG. 3, by means of the hand gesture. FIG. 4A shows a pattern image captured by the image acquiring unit 125 during touching with a finger of the user, and FIG. 4B shows a pattern image captured by the image acquiring unit 125 during releasing of the finger of the user. As shown in FIG. 4A, when a user touches a surface of the print medium with a finger 360, the finger 360 and the surface of the pattern image are almost flush with each other. Thus, it can be recognized that great changes in distortion, brightness, thickness or the like of the pattern image are not generated since the changes may rarely occur at a finger tip. However, in FIG. 4B, when a user releases the finger 360 from the surface, it can be recognized that great changes in the pattern image 350 are generated since the changes occur due to a difference of the perspective between the finger 360 and the surface of the pattern image.

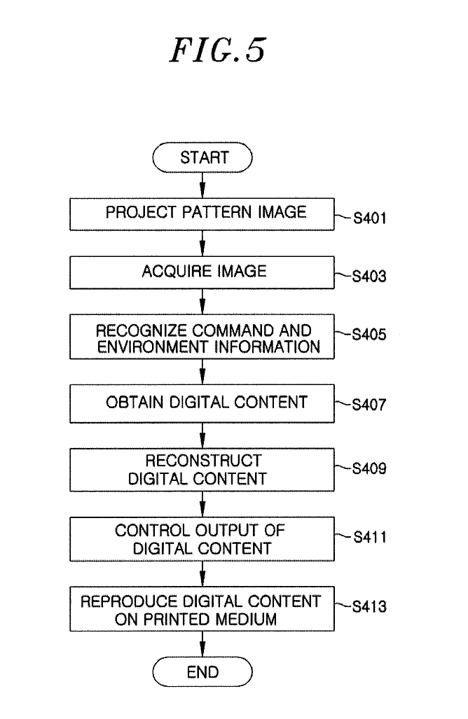

FIG. 5 is a flowchart illustrating a method for exhibiting mixed reality based on a print medium in accordance with an embodiment of the present invention.

First, in step S401, the pattern image output unit 110 projects a pattern image such as the grid image 350 onto a surface of a print medium 370 as shown in FIG. 3.

A user may then issues a user input command by taking a specific gesture on a printed matter in the print medium with a finger as described with reference to FIGS. 6A to 6J. The image acquiring unit 125 acquires an image of the surface of the print medium 370 with the pattern image on which the hand gesture is taken, and provides the captured image to the environment recognizing unit 110 and the command recognizing unit 130 in step S403.

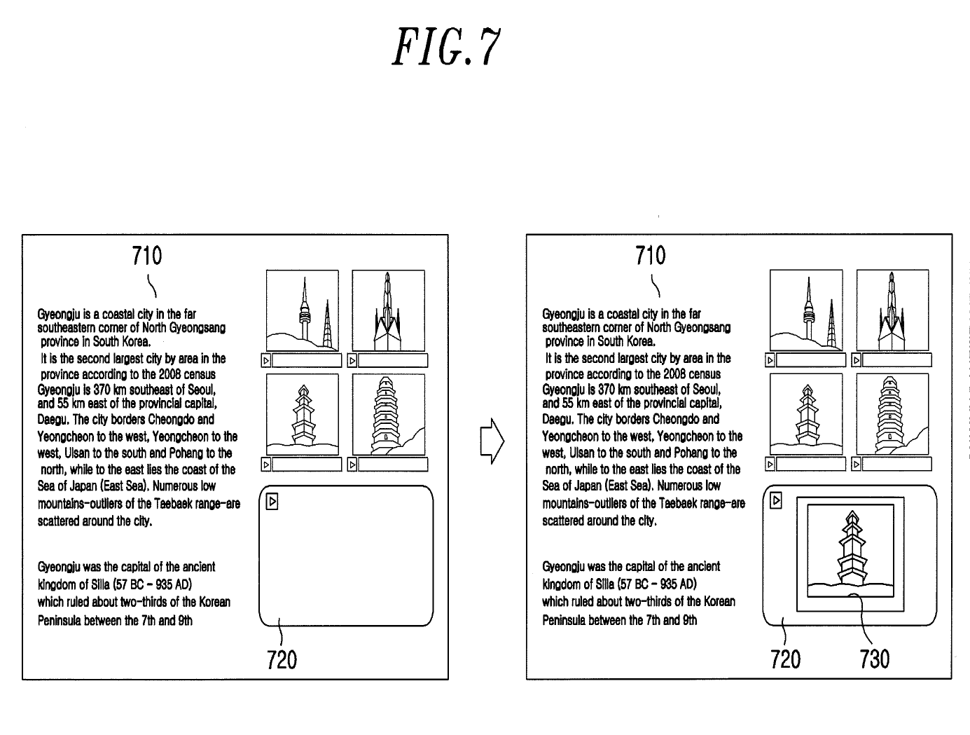

Then, the environment recognizing unit 110 analyzes the captured image for the print medium to find a display area appropriated for exhibiting digital content corresponding to a printed matter such as word, picture, image, etc. selected by the hand gesture, and collect display environment information including at least one or all of information about size, brightness, flat state or distorted state of the display area. For example, the environment recognizing unit 110 identifies color distribution in the captured image, and as shown in FIG. 7, recognizes an empty space 720 to define the display area of the print medium 710.

The command recognizing unit 125 detects the change in the pattern image and matches the hand gesture with the command models stored in the command model database 140, thereby recognizing a user input command based on the matching result in step S405. Such the hand gesture corresponding to the user input command may be any one of the hand gestures shown in FIGS. 6A to 6J.

When the user input command and the environment information are recognized through step S405, the content output unit 310 obtains digital content corresponding to the selected printed matter from the content creation module 200 in step S407.

The image correction unit 110 then reconstructs or formats the digital content based on the display environment information in step S409. For example, the image correction unit 320 changes colors and brightness of the digital content to be provided by the content output unit 310 based on the display environment information. Colors and/or brightness desired to be actually given may be differently reproduced depending on features of the display area on which the digital content is projected. Thus, the image correction unit 320 corrects such colors and/or brightness in advance. Also, when the display area to be projected is not flat, image distortion may be caused. Hence, it is compensated in advance by a geometric correction of the image of the digital content.

Next, the content output unit 310 controls the output of the digital content in step S411 to exhibit the digital content 730 on the display area 720 in the print medium 710 as shown in FIG. 7 in step S413.

The method for exhibiting mixed reality based on a print medium in accordance with the embodiment of the present invention as described above may be recorded with a computer program. Codes and code segments constituting the computer program may be easily inferred by a programmer in the art. Further, the computer program may be stored in a computer-readable storage medium that can be read by a computer, and read and executed by a computer, the apparatus for exhibiting mixed reality based on a print medium in accordance with the embodiment of the present invention, or the like, thereby implementing the method for exhibiting mixed reality based on a print medium. The computer-readable storage medium includes a magnetic recording medium, an optical recording medium, and a carrier wave medium.

In accordance with the embodiment of the present invention, a printed matter on a print medium and a virtual digital content may be integrated with each other, so as to be displayed on a display area on the print medium in the real world, thus allowing for an intuitive user input. Further, recognition of a hand gesture of a user and a reproduction of the virtual digital content may be utilized without a separate marker or sensing device.

Thus, the mixed reality exhibiting apparatus in accordance with the embodiment may be used in mobile equipment as well as the existing projector system. The virtual digital content may be exhibited directly onto the printed matter in the real world, which may provide a user with a new experience, increase utilization of a real-world object such as a print medium and digital content, and enhance reuse of content.

In addition, the integration of reality information and virtual information with a real-world medium may allow for correspondence of an information exhibition space. Also, a user interaction may be performed between virtual digital information and a printed matter of the real-world medium, thereby allowing for correspondence with a user input space. Moreover, use of a simplified effective input/output method which can be actually used as well as being conceptually designed may result in improvement of user convenience.

While the invention has been shown and described with respect to the particular embodiments, the present invention is not limited thereto. It will be understood by those skilled in the art that various changes and modification may be made.

What is claimed is:

1. An apparatus for exhibiting mixed reality based on a print medium, comprising:
a command identification module configured to identify a hand gesture of a user performed on a printer matter in the print medium to recognize a user input command corresponding to the hand gesture; and
a content reproduction module configured to provide a digital content corresponding to the printed matter onto a display area on the print medium.

2. The apparatus of claim 1, wherein the command identification module comprises:
a pattern image output unit configured to generate a pattern image on the printed medium, the hand gesture causes a change in the pattern image;
an image acquiring unit configured to capture an image of the surface of the printed medium, wherein the captured image has the pattern image included therein, and wherein the hand gesture causes the change in the pattern image; and
a command recognizing unit configured to detect the pattern image caused by the hand gesture to recognize the user input command corresponding to the hand gesture.

3. The apparatus of claim 1, wherein the pattern image includes an image in a grid form projected onto the print medium at a preset period.

4. The apparatus of claim 3, wherein the pattern image includes an infrared image invisible to the user.

5. The apparatus of claim 2, wherein the command identification module further comprises a command model database that stores a plurality of command models corresponding to hand gestures representative of user input commands; and
wherein the command recognition unit is configured to match the hand gesture with the command models to find out a command model corresponding to the hand gesture.

6. The apparatus of claim 1, wherein the command identification module further comprises an environment recognizing unit that is configured to analyze the captured image of the print medium to find the display area appropriate for presenting the digital content.

7. The apparatus of claim 6, wherein the environment recognizing unit is further configured to collect display environment information from the captured image of the print medium, the display environment information including at least one of information related to size, brightness, flat state or distorted state of the display area.

8. The apparatus of claim 7, further comprising a content management module that is configured to format the digital content based on the display environment information of the display area and provide the digital content to the content reproduction module.

9. The apparatus of claim 7, wherein the content reproduction module comprises an image correction unit that is configured to correct the image of the digital content based on the display environment information.

10. A method for exhibiting mixed reality based on a print medium, comprising:
generating a pattern image onto the print medium, wherein a hand gesture of a user is interacted with a printed matter in the printed medium to produce a user input command;
identifying the hand gesture causing a change in the pattern image to recognize the user input command; and
projecting digital content corresponding to the printed matter onto a display area of the print medium depending on the user input command.

11. The method of claim 10, wherein said generating a pattern image onto the print medium comprises projecting an image in a grid form onto the print medium at a preset period.

12. The method of claim 10, wherein said identifying the hand gesture comprises:
capturing an image of the print medium, the captured image including the pattern image;
detecting the change in the pattern image caused by the hand gesture; and
matching the hand gesture with a plurality of command models to find out a command model corresponding to the user input command.

13. The method of claim 12, wherein the pattern image includes an infrared image invisible to the user.

14. The method of claim 10, further comprising:
analyzing the captured image to find a display area appropriate for reproducing the digital content on the print medium.

15. The method of claim 12, further comprising:
collecting display environment information including at least one of information related to size, brightness, flat state and distorted state of the display area.

16. The method of claim 14, further comprising:
formatting the digital content based on the collected display environment information.

17. The method of claim 14, further comprising:
correcting an image of the digital content reproduced on the display area based on the collected display environment information.
